(19) United States
(12) Patent Application Publication
(10) Pub. No.: US 2008/0198620 A1
(43) Pub. Date: Aug. 21, 2008

(54) Backlit Communication Display

(75) Inventors: Eric Bihr, Meys (FR); Flavien Bergonnier, Souzy (FR)

Correspondence Address: HESLIN ROTHENBERG FARLEY & MESITI PC, 5 COLUMBIA CIRCLE, ALBANY, NY, 12203, US

(73) Assignee: PRISMAFLEX INTERNATIONAL, Haute Rivoire (FR)

(21) Appl. No.: 11/917,014

(22) PCT Filed: Jun. 30, 2006
(86) PCT No.: PCT/FR2006/050656

§ 371 Date: Dec. 10, 2007

(30) Foreign Application Priority Data
Jun. 30, 2005 (FR) 05.51860

(51) Int. Cl. F21V 7/04

(52) U.S. Cl. 362/603

(57) ABSTRACT

Communication display comprises a light source for backlighting an advertising spot or similar, arranged on a support. The light source comprises a web of optical fibres arranged facing the back of the support and adapted for emitting light laterally. Optical fibres present on at last one edge of the web are assembled in a plurality of bundles, each bundle being equipped at its free end with an assembling ring for securing each of the fibres with regard to others of the same bundle. The light source also includes a plurality of point sources facing at least one edge of the web of optical fibres, and convergent optical systems arranged facing each point source for uniformly collimating light rays emitted by the point sources towards the optical fibres. The convergent optical systems are arranged in a ball joint connection with centering supports and members for aligning the assembling rings.

### TECHNICAL FIELD

The invention relates to the field of communication displays such as advertising boards or light signs. Such displays may thus comprise a light source for backlighting an advertising spot arranged on a support.

The invention relates more particularly to a particular arrangement for forming a light source using a web of optical fibres suitable for emitting the light laterally.

### PRIOR ART

In general, backlit communication displays comprise a plurality of light sources, of the “fluorescent tube” type, arranged at the back of the support comprising the advertising spot.

However, when such light sources are used, it is necessary to separate them from the support, for a better diffusion of the light and to avoid the appearance of zones having a different intensity on the support. In fact, when the support is placed close to the fluorescent tubes, the light transmitted through the support is not uniform, and this is unattractive for an advertising support.

In consequence, this type of display must, on the one hand, comprise a large number of “fluorescent tube” type sources, in order to generate a sufficient light intensity, and, on the other, have a substantial thickness, in order to diffuse the light uniformly on the support.

Communication displays are also known comprising a light source in the form of optical fibres for transmitting the light laterally. Such a display has been described in particular in document U.S. Pat. No. 5,021,928. In this display, the optical fibres are assembled and introduced at various locations in a coupling suitable for transmitting the light emitted by a light generator. Such a generator has a considerable size, and must consequently be positioned outside the display. This arrangement serves to generate a diffuse light immediately next to the display support, and thereby to reduce the thickness of such a display.

In this case, however, there is only one light source, and it must generate a very high light intensity to light the display completely. Furthermore, this light source is inappropriate for lighting very large displays, and particularly light signs which may have a very large surface area. Finally, this type of high intensity light generator is extremely costly and incurs high maintenance costs, because the lighting element needs regular replacement.

Thus, it is the object of the invention to permit the backlighting of advertising supports in a compact space and with low fabrication and operating costs.

Sidelit displays are also known as described in document U.S. Pat. No. 4,885,663, comprising a plurality of interwoven optical fibres embedded in a translucent material having a refractive index different from that of the optical fibre material. The fibres are grouped into bundles at their ends, each equipped with a connector serving as an interface between a point light source and the fibres.

However, in this case, the light emitted by the point sources is not collimated. Considering only the numerical opening of the optical fibres, only an infinitesimal part of the light beam issuing from the source is thereby transmitted by the fibres. Moreover, the light may be reflected on the connector and not be transmitted by the fibres. In any case, this causes non-negligible losses.

Furthermore, the positioning of the fibres directly facing each source is not automatic, and may prove to be complex to carry out manually.

In consequence, it is a second object of the invention to transmit the maximum of light energy emitted by the point sources while facilitating the positioning of the bundles of optical fibres facing the point sources.

### SUMMARY OF THE INVENTION

The invention therefore relates to a communication display comprising a light source suitable for backlighting an advertising spot or similar, arranged on a support.

In practice, the light source comprises a web of optical fibres arranged facing the back of the support and suitable for emitting the light laterally, the optical fibres being present on at least one edge of the web assembled in a plurality of bundles.

Inside the web, the optical fibres may be maintained at a predefined distance. Such a result can be obtained in particular by adhesively joining the fibres independently to a sheet which may be reflecting. In this way, the light transmitted by the fibres escapes laterally at a single side of the web. This result can also be obtained by using woven webs in which the optical fibres are present in a warp and/or weft arrangement.

The web may be made by a method for weaving optical fibres, as described in document WO 2005/026423. This particular embodiment confers numerous advantages in terms of flexibility of the light source, which making it usable to light skewed surfaces. Moreover, the woven configuration is also advantageous for transporting the web, because it can be rolled. Complementarily, its weight is reduced and it has a small thickness. However, it is advantageous to separate the web from the support by a minimum spacing in order to smooth the visual heterogeneity defects of the light source. This minimum spacing is therefore a function of the web used and particularly the number of optical fibres. By way of example, good results have been obtained with a spacing of between 20 and 100 mm.

Furthermore, a weave using optical fibres in a warp serves to prepare a very large light source, of which the length is determined by the length of the weft.

Each fibre bundle is equipped at its end with an assembling ring to secure each of the fibres with respect to the others of the same bundle. In other words, the optical fibres are grouped in a plurality of subsets at their free end, using rings into which they penetrate.

Furthermore, the light source comprises a plurality of point sources facing at least one edge of the web of optical fibres. Convergent optical systems are arranged facing each point source for uniformly collimating the light rays emitted by the point sources towards the optical fibres.

In other words, convergent optical systems are inserted between, on the one hand, the point light sources, and on the other, at least one ring for assembling a bundle of optical fibres. This improves the directivity of the light beam emitted by the point source towards the optical fibres.

According to the invention, the display is characterized in that the said convergent optical systems are arranged in a ball joint connection with, on the one hand, centering supports and, on the other, members for aligning the assembling rings.

In other words, the alignment between the light source and the ring can be provided by a ball joint at each end of the optics. In this way, an accurate and automatic positioning of the optical systems is obtained with, on the one hand, the opposite light source, using centering means and, on the other, with the opposite optical fibre bundle using alignment members. The accuracy of this alignment therefore serves to guarantee the maximum efficiency by transmitting all the light emitted by the sources to the opposite optical fibres.

Advantageously, the assembling rings can secure the optical fibres by a hexagonal crimping. In other words, the assembling rings can be distorted in order to immobilise the fibres in a predefined position.

In this particular case, the intensity of the crimping force must be sufficiently high to maintain the optical fibres in the shape of a bundle and to eliminate the air spaces between the fibres by compaction. However, the intensity of this force must not be excessive, to avoid destroying the fibres by compression.

The hexagonal crimping of the assembling ring is advantageous because it serves to reduce the coupling losses. In fact, this deformation of the assembling ring serves to confer on each of the fibres a shape approaching a hexagon. In this way, the air interstices initially present between the fibres are reduced to the minimum. In consequence, the surface density of the fibre beam and the yield of the light transmitted by the source to the optical fibres are maximized.

Moreover, in case of misalignment of the light source and the beam, the hexagonal shape of the fibre bundle serves to minimize the number of fibres not lit by the point source, because only the corners of the hexagon are not lit. Thus, when the beam has a hexagonal shape, a misalignment tolerance of the light spot emitted by the source is allowable between the circle inscribed in and the circle circumscribing the hexagon.

In fact, the cross section of the light spot emitted by the source has a direct influence on the light transmission efficiency in the fibres, and also on the uniformity of the light emitted by the textile web.

More precisely, when the cross section of the spot is smaller than the cross section of the circle inscribed in the hexagon, and when the latter is correctly aligned, all the light energy is transmitted to the optical fibres, but some of them are not lit by the spot. The light transmission efficiency is then a maximum, but black lines corresponding to unlit fibres appear on the web.

Conversely, when the cross section of the light spot is larger than the cross section of the circle circumscribed on the hexagon with a good alignment, all the optical fibres are lit. However, part of the light emitted by the source is not transmitted to the optical fibres, and the transmission efficiency is then lower.

The hexagonal shape of the assembling rings lit by a light spot of which the cross section is between the inscribed circle and the circumscribed circle thereby serves to guarantee the best balance between maximum efficiency and uniformity of the light emitted.

According to various particular embodiments, in which the assembling rings secure the optical fibres by a hexagonal crimping, the light source of the communication display may, in particular not comprise convergent optical systems arranged facing each point source. Similarly, in certain cases, the optical systems may be simply arranged facing the assembling rings crimped in a hexagonal shape, without necessarily having a ball joint connection with one of the members securing them in position.

According to other embodiments, the fibres may also be cemented or welded together to prevent their movement once introduced into the assembling ring.

Once the fibres are immobilized in the ring, the end of the bundle can be polished in order to improve the light transmission in the fibres and reduce the reflection of the incident rays in this surface.

Such crimping rings are therefore prepared from a soft metal and particularly from an alloy based on copper or aluminium. They may have a flared or tulip shape at the fibre introduction end, in order to avoid their damage in contact with a cutting edge.

In practice, the point sources may be arranged on either side of the web in order to light all the optical fibres via their two ends.

In this way, the web comprises optical fibres having a free end on each side of the web. This embodiment further serves to increase the light intensity, which may prove important for backlighting a very large display.

Moreover, the plurality of point sources may be arranged laterally with regard to the web of optical fibres according to various alternatives.

According to a first alternative, the point sources may be arranged on a mechanical support. Its shape then matches the edge of the web. In practice, such a mechanical support is generally straight to permit the preparation of flat and stretched displays, but for certain applications, it may have a particular curvature and serve to confer a skewed surface on the web.

Advantageously, a communication display may comprise a rail in which a plurality of housings are arranged for positioning the assembling rings opposite a point source.

In other words, the assembling rings are introduced into a housing, and then immobilized in order to remain constantly opposite a point source. Subsequently, the rail in which the housings are made follows the curvature of the profile on which the point sources are arranged. In this way, the rails are advantageously joined with a profile facing them.

According to this first alternative, the mechanical supports may be joined together at their ends, and may form a frame.

In other words, the mechanical supports accommodating the light sources may serve as a support for the web, for maintaining this web in position on the back of the advertising spot. The frame thereby formed may then cooperate with means for joining the communication display.

According to a particular embodiment, the communication display may comprise a duplicable structure of a plurality of juxtaposed frames.

In other words, a communication display may comprise a plurality of frames formed by mechanical supports on which the point sources are arranged. In this way, it is possible to subdivide the lighting of an advertising spot into a plurality of sections, by means of different webs of optical fibres. The various sections may in particular be substantially identical, in order to permit considerable modularity and adaptability according to the size of the advertising spots to be lit. Such an arrangement also serves to facilitate the transport of such display because it can then be dismantled into several sections.

In practice, a single mechanical support may belong to two juxtaposed frames, that is, the same mechanical support may serve to maintain a plurality of successive webs in position. In this case, the rings for assembling the two juxtaposed webs into bundles are arranged in housings which may be located on the same rail, in the case in which the point sources are located on the single side of the mechanical support. However, in the case in which the point sources are arranged on both sides of the mechanical support, the latter may be positioned between two rails suitable for receiving the assembling rings of each web independently.

According to a particular embodiment, the mechanical supports may comprise fins for dissipating the heat generated by the point sources.

In fact, the fins serve to increase the heat exchange area of the mechanical supports with the surrounding air, and thereby improve the removal of the heat generated by the point sources.

Thus, the mechanical support may be in the form of a profile playing the role of a rigid upright suitable for forming the side of a frame, and a support dissipating the heat generated by the point sources. Such a profile may advantageously be made from an aluminium alloy.

According to a second alternative, the sources may be connected exclusively and directly to the rings. In this case, the sources are simply connected together by means of an electric wire and are assembled to form a garland of several point sources.

Ancillary means can then be used to stretch the web, or more generally to maintainit in a predefined position with regard to the information message to be lit.

The positioning of the point sources can be provided according to various alternatives.

Thus, according to a first alternative, the point sources may be arranged each facing the free end of a predefined fibre bundle. In this way, the light intensity generated by a point source is completely transmitted through a predefined bundle. This arrangement is prepared by aligning the axis of symmetry of one assembling ring with the optical axis of a point source.

According to a second alternative, the point sources may be arranged each facing a plurality of free ends of fibre bundles. In other words, the bundles may be grouped laterally at the edge of the web and a point source may light a plurality of free ends of bundles. In this way, it is possible to use a smaller number of sources than the number of fibre bundles present in the same edge of the web.

In practice, the communication display may comprise a control unit for controlling the energization and the lighting intensity of the point sources.

In this way, it is possible to adapt or vary the lighting of the display according to several parameters. It is possible in particular to progressively light an advertising spot or even to have it flashed for certain applications and particularly that of light signs, or even to vary the chromaticity of the light source.

The lighting intensity may also be controlled according to the outdoor luminosity or the advertising spot, when the latter is replaced, which occurs periodically on conventional displays, and consequently on so-called scrolled displays.

According to a particular embodiment, the power supply of the point sources can be controlled by current and/or by voltage, according to the type of component used. In this way, problems of excessive power supply are avoided, and that the sources are protected from any risk of breakdown.

In fact, the sources may be of several types and in particular, some may have a certain vulnerability to excessive power supply. Mention can be made in particular of point sources of the white or three-colour light emitting diode type, as well as light emitting diodes of the “organic” type, also called O-LED or laser diodes.

The method for implementing the invention, and the advantages it provides, clearly appear from the description of the embodiment that follows, provided for information and non-limiting, in conjunction with the appended figures, in which:

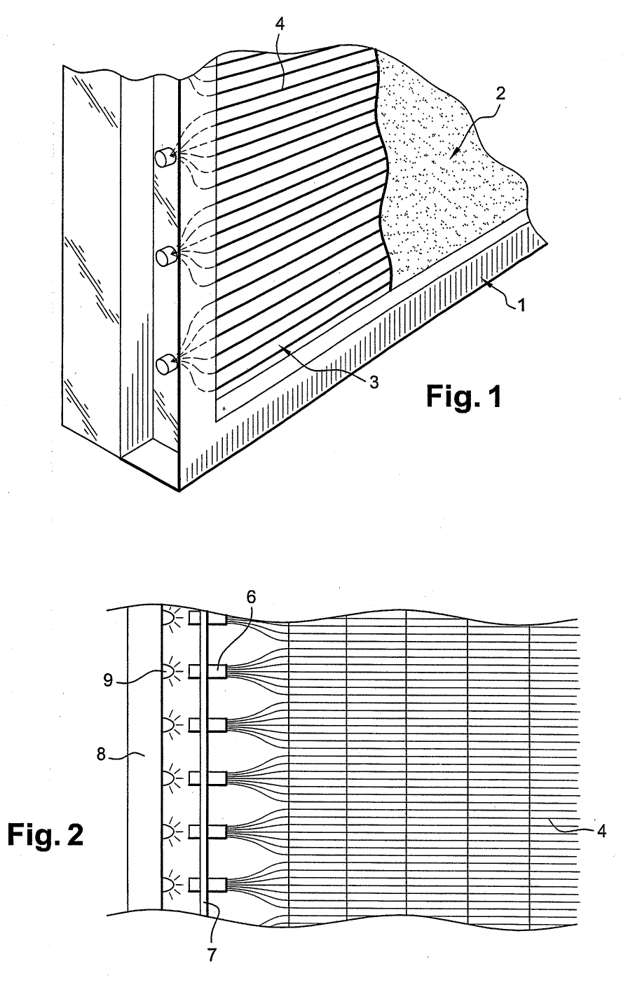

FIG. 1 is a partial perspective view of a communication display, according to the invention,

FIG. 2 is a front view of the light source, according to the invention,

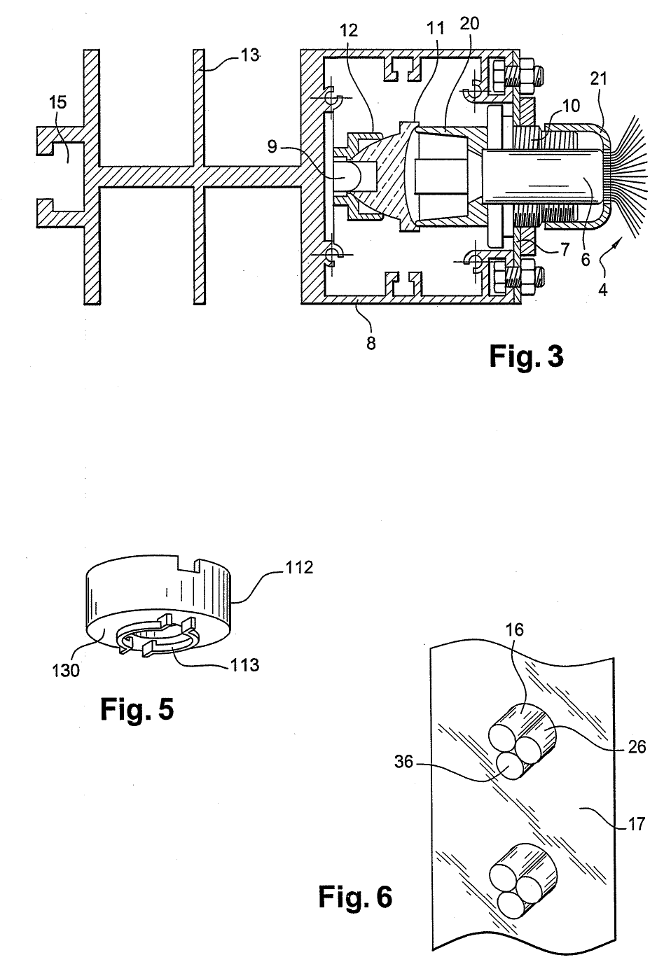

FIG. 3 is a cross section of a first alternative of the light source,

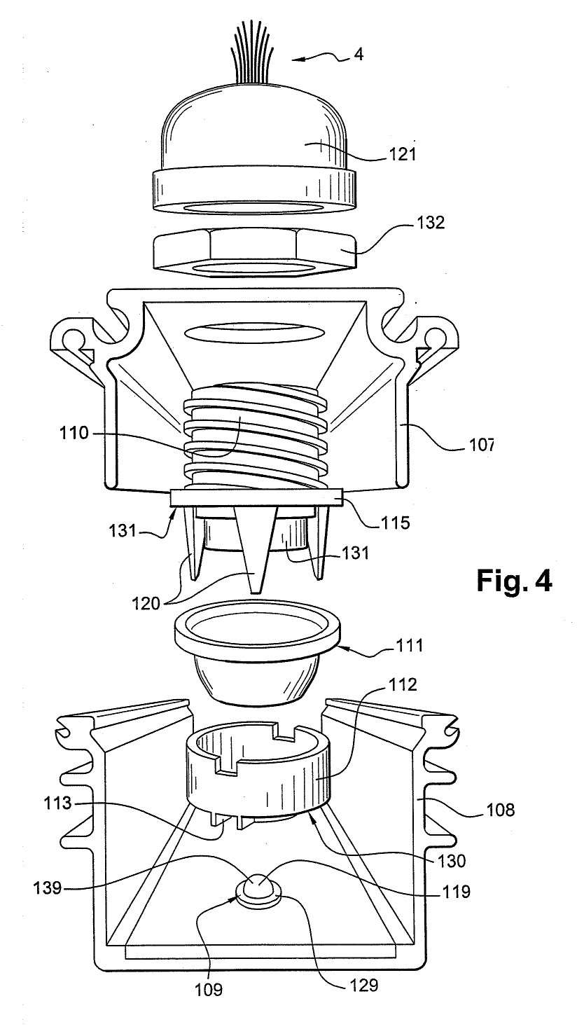

FIG. 4 is an exploded perspective view of a second alternative of the light source,

FIG. 5 is a perspective view from below of a type of centering support for a convergent optical system,

FIG. 6 is a perspective view of a third alternative of the light source, according to the invention,

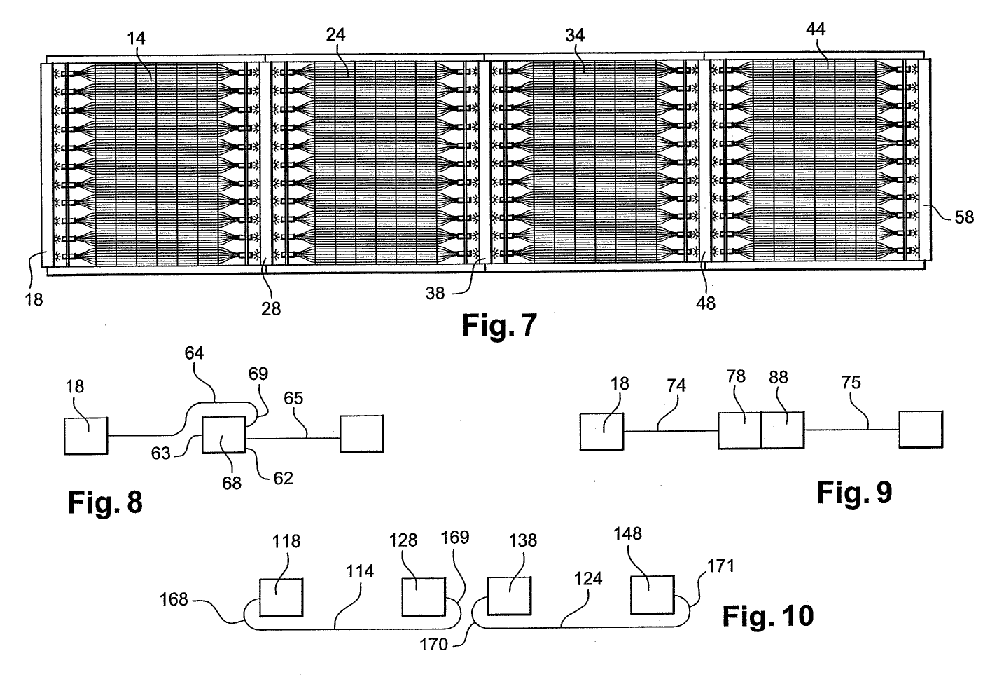

FIG. 7 is a front view of a light source formed by a plurality of duplicable portions, according to the invention,

FIGS. 8, 9 and 10 are plan views according to three alternatives at the junction between two juxtaposed light sources.

### METHOD FOR IMPLEMENTING THE INVENTION

As already stated, the invention relates to a communication display comprising a light source suitable for backlighting an advertising spot arranged on a support.

As shown in FIG. 1, the communication display (1) may have a very small thickness. The front of this communication display therefore comprises a support for an advertising spot (2) backlit by a light source (3).

This light source (3) has a web (4) of optical fibres arranged facing the back of the support (2). The web (4) may in particular be in the form of a fabric comprising white 100 deniers polyester yarns in a warp, the weave density being 150 threads per inch or about 60 threads percentimetre. The weft may comprise both white 100 deniers polyester yams and optical fibres. The optical fibres comprise a PMMA core and a fluorinated polymer sheath (PVDF). The density of the optical fibres is about 16 fibres percentimetre, their diameter is 500 μm and their linear weight is 0.3 g/m. The optical fibres are therefore woven in a satin weave of 16.

As shown in FIG. 2, the ends of each of the optical fibres are assembled at an assembling ring (6) for securing each of the fibres in a predefined position with regard to the others.

The various assembling rings (6) are positioned inside a housing made in a rail (7). This rail (7) serves both to accurately position the assembling rings facing a point light source (9) and for stretching the web (4) to make it substantially flat.

Such position securing arrangements may also be provided on the four edges of the web (4). In this way, when the web (4) is made using a method for weaving a plurality of optical fibres, the latter may be both positioned in a warp and a weft, in order to light the web (4) in two directions. However, in practice the optical fibres may only be present in one of the warp or weft directions.

As shown the point sources (9) are arranged on a mechanical support (8). Such a support (8) serves both as a rigid frame for maintaining the web (4) substantially flat, but also for dissipating the heat generated by the point sources (9).

As shown in FIG. 3, the light source may comprise an optical system (11) in order to concentrate the light beam emitted by the point source (9), exclusively in the direction of the assembling ring (6). Such a convergent optical system (11) may have a centering support (12) for its automatic positioning on the optical axis of the point source (9).

Furthermore, an alignment member (20) also serves to automatically and accurately position the assembling ring (6) on the optical axis of the source (9). In fact, the alignment member (20) cooperates with a housing (10) added on to the rail (7) and serving to position an assembling ring (6) facing a source (9). A nut (21) then serves to immobilize the assembling ring (6) with regard to the rail (7).

According to this representation, the point sources (9) are arranged on a mechanical support (8) in the form of a straight profile. Such a profile may in particular comprise a plurality of cooling films (13) for improving the dissipation of the heat generated by the point sources (9). It may also comprise a groove (15) for joining the ends facing a plurality of profiles (8) and thereby for producing a rigid frame.

As shown in FIG. 4, the rail (107) may be clipped to the profile (108) in order to apply a pressure, via the alignment member (120), to the convergent optical system (111). The convergent optical system (111) being arranged in a ball joint connection with, on the one hand, the centering support (112) and, on the other, the alignment member (120), the force applied by the rail (107) serves to preserve a coaxiality between the various elements.

In this case, the light emitting diode (109) comprises a base (119) cemented to a printed circuit. This base may have a cylindrical shape and comprise a flat bearing surface (129) at the centre of which is a bulb (139) covering the transmitter. Thus, the back (130) of the centering support (112) may come into contact with the bearing surface (129) according to a flat bearing type linkage. Fixing brackets (113) serve to immobilize the centering support (112) on the base (119).

The convergent optical system (111) then comes into contact with a hemispherical or parabolic portion of the centering support (112).

Furthermore, the housing (110) and the alignment member (120) may form a single part added on to the rail (107). The alignment member (120) consists in this case of three points intended to generate three point contacts with a hemispherical or parabolic portion of the convergent optical system (111) and thereby a ball type joint. Furthermore, the three points may have a deformation capacity for compensating for the uncertainties relative, on the one hand, to the fabrication dimensions of the various elements inserted between the profile (108) and the rail (107), and, on the other, to the positioning of the diode (109) with regard to the profile (108).

A support collar (131) may comprise flats (115) in order to facilitate the joining of the housing (110) to the rail (107). Thus, a nut (132) may be tightened without requiring the rotational locking of the housing (110) by ancillary means.

As shown in FIG. 5, the centering support (112) is tightly mounted on the base (119) by means of fixing brackets (113) having an elasticity allowing deformation and matching with the outer shape of the base (119). Thus, the fixing brackets (113) may define a cylindrical contour having a smaller diameter than the matching cylindrical shape of the base.

As shown in FIG. 6, a rail (17) may serve to arrange various assembling rings (16, 26, 36) at a single point. In this way, a point source can be arranged facing a plurality of assembling rings (16, 26, 36). Advantageously, to avoid problems of heterogeneity of the light source, seven hexagonal assembling rings may be arranged facing a point source. Furthermore, with this hexagonal arrangement of the assembling rings, the light may be transmitted to the optical fibres with maximum efficiency.

Obviously, a technical system as previously described may also be positioned between the point source and the various assembling rings.

As shown in FIG. 7, the communication display may comprise a light surface formed by the juxtaposition of a plurality of frames each comprising a web of optical fibres (14, 24, 34, 44). In this case, the profiles (18, 58) comprise point light sources at one of the faces. The profiles (28, 38, 48) comprise light sources arranged on either side, on each of their sides facing a web.

Such a structure is consequently very compact and modulable, and allows adaptability to any dimension of the communication display. The various profiles (18, 28, 38, 48, 58) are then connected together by joining elements which may themselves be profiles of the same type.

This structure also serves to facilitate the transport of the display, which can be dismantled into several modules intended to be assembled on the installation site of the communication display.

As shown in FIG. 8, it is also possible to use a profile (68) which comprises the duplicate of the point sources with regard to the profile (18). In fact, a foldback (69) of the web of optical fibres (64) serves to add the various assembling rings at the side (62) of the profile (68), arranged facing the web (65).

In this way, the back (63) of the profile (68) may have arrangements promoting the removal of the heat generated by the point sources which it comprises. Moreover, this arrangement serves to use a small number of profiles and, in consequence, this solution serves to produce a lightweight light source.

As shown in FIG. 9, two webs (74, 75) may also be juxtaposed by using two profiles (78, 88), of which the backs are positioned opposite. This arrangement has considerable rigidity and stiffness and may consequently be used for very large communication displays.

As shown in FIG. 10, the profiles (118, 128, 138, 148) may be arranged on the back of the webs of optical fibres (114, 124). This arrangement guarantees good uniformity of the light emitted by each web, because the lighting part of the webs can begin as close as possible to one another at the foldbacks (169) and (170). The foldbacks (168) and (171) are not useful in terms of uniformity of the light source, but they serve to limit the space occupied by the bearing structure of the webs (114, 124). Such foldbacks (168, 169, 170, 171) can be provided using rods arranged in parallel to the profiles (118, 128, 138, 148).

Furthermore, due to the high curvature of the webs of optical fibres (114, 124) at the foldbacks (168, 169, 170, 171), a light overintensity may occur, which is harmful to the uniformity of the light source. Thus, the borders of the webs of optical fibres (114, 124) may comprise a different treatment from the rest of the central lighting part. According to a particular embodiment, the borders may also have no treatment for emitting the light laterally.

It appears from the above that a communication display according to the invention comprises numerous advantages, and in particular:

it has a very small thickness and can be assembled quickly,

it has a very advantageous modularity, thereby permitting adjustment to any size of communication display by means of standard modular elements,

it allows luminous effects such as flashing or a variation in intensity if necessary,

its maintenance is extremely simple, because the lifetime of point sources may be several tens of thousands of hours.

1. Communication display comprising a light source for backlighting an advertising spot or similar, arranged on a support, the light source comprising:
a web of optical fibres arranged facing a back of the support and adapted for emitting light laterally, optical fibres present on at least one edge of the web being assembled in a plurality of bundles, each of the bundles being equipped at a free end with an assembling ring for securing each of the fibres with regard to other fibres of a same bundle;
a plurality of point sources facing at least one edge of the web of optical fibres, convergent optical systems being arranged facing each point source for uniformly collimating light rays emitted by the point sources towards the optical fibres;
wherein the convergent optical systems are arranged in a ball joint connection with centering supports and members for aligning assembling rings.

2. Communication display according to claim 1, wherein the assembling rings secure the optical fibres by a hexagonal crimping.

3. Communication display according to claim 1, wherein the point sources are arranged on either side of the web in order to light all the optical fibres via their two ends.

4. Communication display according to claim 1, wherein said point sources are arranged on mechanical supports.

5. Communication display according to claim 4, wherein the mechanical supports are joined together at their ends and form a frame.

6. Communication display according to claim 5, further comprising a duplicable structure of a plurality of juxtaposed frames.

7. Communication display according to claim 6, wherein a same mechanical support belongs to two juxtaposed frames.

8. Communication display according to claim, wherein the mechanical supports comprise fins for dissipating heat generated by the point sources.

9. Communication display according to claim 1, wherein said point sources are each arranged facing a free end of a predefined bundle of fibres.

10. Communication display according to claim 1, wherein said point sources are each arranged facing a plurality of free ends of fibre bundles.

11. Communication display according to claim 1, further comprising a control unit for controlling energization and lighting intensity of the point sources.
